(19) United States
(12) Patent Application Publication
(10) Pub. No.: US 2023/0400679 A1
(43) Pub. Date: Dec. 14, 2023

(54) SCANNING PROJECTOR PIXEL PLACEMENT

(71) Applicant: GOOGLE LLC, Mountain View, CA (US)

(72) Inventors: Stuart James Myron Nicholson, Waterloo (CA); Jerrold Richard Randell, Waterloo (CA)

(21) Appl. No.: 18/035,389

(22) PCT Filed: Dec. 30, 2020
(86) PCT No.: PCT/US2020/067510

§ 371 Date: May 4, 2023

(51) Int. Cl. G02B 26/10; G02B 27/01

(52) U.S. Cl. CPC G02B 26/101; G02B 27/017; G02B 2027/0196; G02B 2027/0178; G02B 2027/014

(57) ABSTRACT

Systems, devices, and techniques are provided for displaying graphical content by modulating an intensity of one or more emitted light beams while redirecting those emitted light beams along a scan path that includes multiple locations of a projection surface Timing information that specifies timing values associated with each of multiple locations on a projection surface of an optical element is received or generated. One or more light beams that each have a respective intensity are emitted, and redirected along a scan path that includes at least some of the multiple locations. During the redirection of the one or more emitted light beams, the respective intensity of each of the one or more emitted light beams is modulated in accordance with the timing information to display one or more pixels of an image at each of the at least some multiple locations.

### BACKGROUND

The optics attached to projection-based display systems often introduce distortions that require resampling graphical data. For example, the complex optics involved in augmented reality (AR) and/or virtual reality (VR) wearable devices such as smart glasses may need to compensate for distortions associated with curved or otherwise uneven display surfaces, as well as those distortions that may be introduced by the human visual system.

Certain approaches to handling such distortions may involve resampling of graphical content. However, such resampling may be associated with information and/or quality losses that drive the development of higher resolution systems. Each additional pixel in a graphics pipeline is more data that needs to be computed, transmitted, processed, and displayed, increasing the energy load of a system — which for wearables and some other projection-based display systems, is a key performance parameter.

### SUMMARY OF EMBODIMENTS

Embodiments of systems, devices, and techniques described herein provide a significant reduction in a quantity of pixels to be displayed via a graphics pipeline by modifying a placement of such pixels for display to an idealized location along a scan path of a projection surface. By modulating an intensity of one or more light beams as those light beams are redirected along the scan path, the location at which a particular pixel is displayed may be effectuated with greater accuracy. In addition to reducing a quantity of pixels being displayed via the associated graphics pipeline, a need for resampling of an image that includes those pixels may also be mitigated or even eliminated.

In one example, a method for displaying an image may comprise receiving timing information specifying timing values associated with each of multiple locations on a projection surface, and displaying the image on the projection surface by: emitting one or more light beams using a first set of intensity values; redirecting the one or more emitted light beams along a scan path that includes at least some of the multiple locations; and modulating, during the redirecting of the one or more emitted light beams along the scan path and in accordance with the timing information, the one or more emitted light beams to display one or more pixels of the image using a respective set of intensity values at each location of the at least some multiple locations.

The method may further comprise generating the timing information for the display device via a calibration process.

The method may further comprise associating each of the at least some multiple to locations with one or more pixels of the image.

Each of the specified timing values may indicate a duration for displaying a pixel of the image using a respective set of intensity values at a respective location on the projection surface.

The projection surface may be part of an optical element that includes at least a portion of one or more eyeglass lenses.

The projection surface may be part of an optical element that includes at least a portion of a vehicle window.

Receiving the timing information may include receiving at least two distinct timing values that are respectively specified for each of at least two adjacent locations of the at least some multiple locations.

The example method therefore in particular comprises that an intensity of each of the one or more emitted light beams is modulated in accordance with the timing information. This may result in intensities of the one or more emitted light beams being varied, while redirecting the emitted light beams along the scan path, depending on a location of an associated pixel on the projection surface also taking into account a timing information for the respective location. Timing information may, for example, indicate a duration for displaying one or more pixels at one or more of the multiple locations on the projection surface. In one example, such timing information may indicate a duration for displaying one or more pixels at one or more of the multiple locations on the projection surface with an intensity specified by an intensity value for the one or more pixels.

In another example, a display system may comprise a processor, to receive timing information that specifies timing values associated with each of multiple locations on a projection surface of an optical element; at least one light emitter to emit, using a first set of intensity values, one or more light beams for displaying an image on the projection surface; a scanning redirector, to redirect the one or more emitted light beams along a scan path that includes at least some of the multiple locations; and a modulation controller, to modulate (during the redirection of the one or more emitted light beams and in accordance with the timing information) the one or more emitted light beams to display one or more pixels of the image using a respective set of intensity values at each location of the at least some multiple locations.

The display system may further comprise the optical element.

The processor may be further to generate the timing information for the display device via a calibration process.

Each of the specified timing values may indicate a duration to display a pixel using a respective set of intensity values at a respective location on the projection surface.

The processor may be further to associate each of the multiple locations on the projection surface with one or more pixels of the image.

The optical element may include at least a portion of one or more eyeglass lenses.

The optical element may include at least a portion of a vehicle window.

At least two of the specified timing values may be distinct values respectively specified for at least two adjacent locations of the multiple locations.

In another example, a head wearable display (HWD) device may comprise an optical element; a processor, to receive timing information that specifies timing values associated with each of multiple locations on the optical element; at least one light emitter, to emit one or more light beams that each have a respective intensity; a scanning redirector, to redirect the one or more emitted light beams along a scan path that includes at least some of the multiple locations; and a modulation controller, to modulate (during the redirection of the one or more emitted light beams and in accordance with the timing information) the respective intensity of each of the one or more emitted light beams to display one or more pixels of an image at each of the at least some multiple locations.

The processor may be further to generate the timing information for the display device via a calibration process.

Each of the specified timing values may indicate a duration to display a set of intensity values for a respective one of the multiple locations.

to The processor may be further to resample the image to associate each of the multiple locations with one or more pixels of the image.

The optical element may include at least a portion of one or more eyeglass lenses.

At least two of the specified timing values may be distinct values respectively specified for at least two adjacent locations of the multiple locations.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a partial-cutaway perspective view of an example wearable heads-up display suitable for implementing one or more embodiments.

FIG. 2 is a block diagram of an optical system 201 in accordance with one or more embodiments.

FIG. 3 depicts alternative arrangements for scanning a simplified pixel grid in accordance with one or more embodiments.

FIG. 4 illustrates a pixel grid and various pixel positioning schema associated with the display of projected pixels associated with the pixel grid, including in accordance with one or more embodiments.

FIG. 5 depicts an example timing block for a modulation controller in accordance with one or more embodiments.

FIG. 6 is a block diagram illustrating an overview of operations of a display system in accordance with one or more embodiments.

FIG. 7 is a component-level block diagram illustrating an example of a system suitable for implementing one or more embodiments.

### DETAILED DESCRIPTION

In projection display systems utilizing one or more dynamic mirrors or other redirection systems to redirect emitted beams of light to display pixels of an image across successive locations in a scan path, the speed at which those dynamic mirrors redirect the light beams is not constant. Typically, a scan mirror accelerates from rest at the beginning of a scan line, moves faster while progressing along the middle of the scan line, and slows towards the end of the scan line in preparation for reversing direction (to either scan and display a next scan line in a reverse direction, or to return to a starting position for scanning and displaying the next scan line in the same direction as the first). Due to this variation in scan speed in the course of a single scan line, the width of the corresponding displayed pixel is not constant. In particular, pixels displayed near the beginning and end of the scan line—when the dynamic mirror is rotating more slowly—may have significantly less width than pixels displayed in the center region of the scan line, when the dynamic mirror is rotating more quickly. Attempts to maintain a constant or near-constant speed for these redirection systems in order to mitigate these disparities typically utilize greater power, such as in order to overcome one or more resonance frequencies associated with such redirection systems.

Embodiments of systems, devices, and techniques described herein provide a significant reduction in a quantity of pixels to be displayed via a graphics pipeline by modifying a placement of such pixels for display to an idealized location along a scan path of a projection surface, such as a curved or otherwise distorted projection surface of one or more optical elements (e.g., an eyeglass lens, window glass, or holographic optical elements). In particular, by varying a timing of intensity modulation during the redirection of light beams along the scan path, rather than using a fixed periodic modulation rate, the location at which a particular pixel is displayed may be specified with greater accuracy. In short, the modulation timing dictates the pixel location and width along the scan path in order to position each individual pixel as desired. In addition to reducing a quantity of pixels being displayed via the associated graphics pipeline, a need for resampling of an image that includes those pixels may also be mitigated or even eliminated.

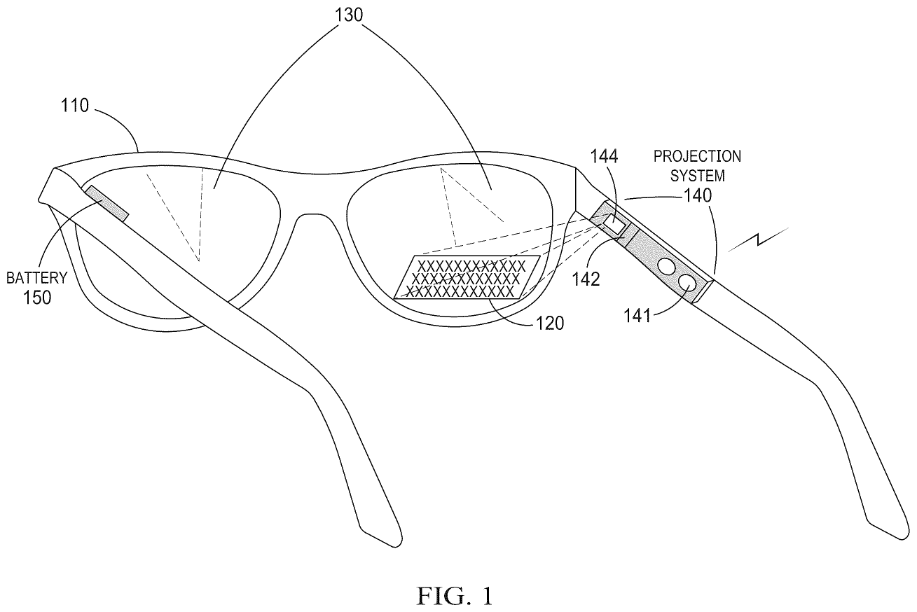

FIG. 1 illustrates a head-worn display (HWD) device 110 in the form of smart glasses that, according to an embodiment, are not much bigger or heavier than a regular pair of eyeglasses. In the depicted embodiment, the HWD device 110 includes an optical element 130 (which may comprise one, or multiple, prescription eyeglass lenses or non-prescription lenses), a projection system 140, and a battery 150.

The projection system 140 may, in at least one embodiment, comprise a MEMS-based projection system, and may communicate wirelessly or in some other manner to a server or mobile device to receive AR/VR content or other content for display via a projection surface display area 120 of the optical element(s) 130. In the depicted embodiment, the projection system 140 includes a light-emitting scanning laser projector (SLP) 144 and a scan mirror 142, which may comprise, as non-limiting examples, a single two-dimensional scan mirror or two one-dimensional scan mirrors (such as MEMS-based or piezo-based scan mirrors). The projection system 140 displays content on the optical element 130 by projecting one or more beams of light emitted by the SLP 144 towards the scan mirror 142 for redirection at an angle appropriate to display the content via the display area 120 on a projection surface of the optical element. In the example shown, a user views real-world images through the transparent lenses 130, and may view projected content via display area 120. The projection system 140 may be coupled to physical controls 141, for instance for power or other controls.

In certain embodiments, the projection system 140 may be coupled to a gaze tracker. The gaze tracker differs from the projection system 140 because it is effectively a camera system aimed at the user's eye rather than the lens to determine at what angle the user's gaze is directed. The gaze tracker may be integrated with the projector system 140 using a non-visible laser to the projection system that shines light onto the eye and the reflected light, reflected by the eye, reaches a photosensor, such as a photodiode, placed as well in the projection system. In another embodiment, the gaze tracker may be separate from the projector system 140, but in communication with components on the smart glasses 110. The gaze tracker may use a frame of reference angle based on the mounting configuration on the smart glasses 110.

In an embodiment, SLP 144 may include multiple laser diodes (e.g., a red laser diode, a green laser diode, and/or a blue laser diode). The SLP 120 may be communicatively coupled to (and support structure 110 may further carry) a processor and a non-transitory processor-readable storage medium or memory storing processor-executable data and/or instructions that, when executed by the processor, cause the processor to control the operation of the SLP 120. For ease of illustration, FIG. 1 does not call out a processor or a memory.

In various embodiments, the battery 150 may be replaceable or rechargeable via wired or wireless means. The battery 150 may provide power to the projection system 140 via wires embedded in the plastic frame, and therefore unseen.

Throughout this specification and the appended claims, the term “carries” and variants such as “carried by” are generally used to refer to a physical coupling between two objects. The physical coupling may be direct physical coupling (i.e., with direct physical contact between the two objects) or indirect physical coupling that may be mediated by one or more additional objects. Thus, the term carries and variants such as “carried by” are meant to generally encompass all manner of direct and indirect physical coupling, including without limitation: carried on, carried within, physically coupled to, and/or supported by, with or without any number of intermediary physical objects therebetween.

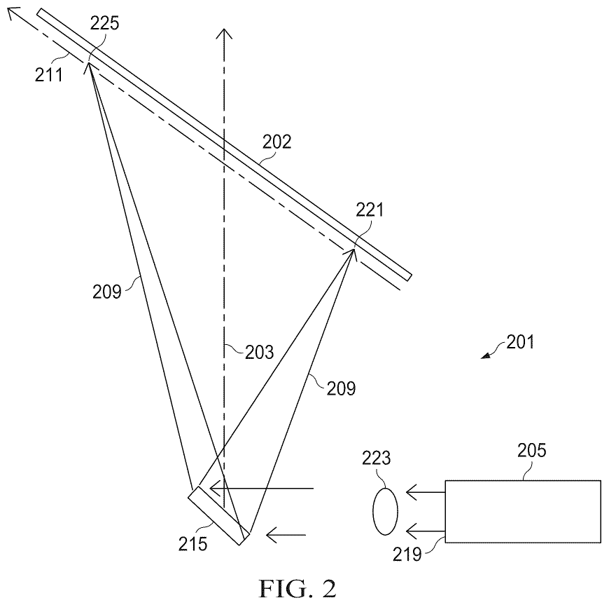

FIG. 2 is a block diagram illustrating an on-axis view of a projection system 201 in accordance with one or more embodiments of the present disclosure. The projection system 201 may be implemented in a head-worn display device 110 as the projection system 140 in FIG. 1. In general, the projection system 201 may display graphical content via a projection surface 202 (such as projection surface display area 120 in FIG. 1) by emitting one or more light beams that are each associated with a respective intensity level, allowing such respective intensity levels to be locally controlled. The projection system 201 may therefore be used, for example, to display individual pixels of an image in each of multiple locations on that projection surface 202.

The projection system 201 projects an image onto the projection surface 202, which is depicted as being strongly non-perpendicular to a chief ray 203 (e.g., meridional ray, or the like) of the projection system 201. In various embodiments, the surface 202 may be reflective, such that an image may be projected on the retina of a viewers eye so that the viewer can perceive the projected image as a real or virtual image.

The term “projection surface” is used in this text to refer to any physical surface towards which light emitted from a light source is projected, and from which the light travels onward to a viewpoint, thereby rendering a projected image visible. For example, the surface may be at least part of a transparent or partially transparent body such as an eyeglass lens, vehicle or other window, or other suitable optical element. It will be appreciated that the term is not used in a narrow sense or to be limited to a physical surface on to which light is projected in order to render visible graphical or other content.

The projection system 201 comprises a light emitter 205 configured to emit a light beam 209, which is scanned across the projection surface 202 via a scanning redirection system 215 to project an image onto the surface 202. In particular, the light emitter 205 emits light from a light source emission surface 219. In the depicted embodiment, the light is transmitted through a lens 223, such as a variable position lens (also called a dynamic lens or a movable lens). The lens 223 can be located between the light emitter 205 and the scanning redirection system 215. In the depicted embodiment, the lens 223 is a variable position lens that can be adjusted to focus the light emitted by the light emitter 205. The light is transmitted through the lens 223 and is incident on the scanning redirection system 215. In some examples, the scanning redirection system 215 can comprise one or more MEMS scanning mirrors. In certain embodiments, some portion or all of the scanning redirection system 215 rotates to scan the light beam 209 across the projection surface 202 in the direction of axis 211 and/or another axis orthogonal to axis 211 across the projection surface, to project an image onto the projection surface.

In general, the lens 223 is to focus the light beam 209 at a virtual focal surface or at the projection surface 202, thereby creating a pixel at point 221 and/or point 225. During the image generation process the scanning redirection system 215 scans the light beam 209 along a scan path that includes multiple locations on the projection surface 202 to project an entire image on the projection surface 202 (e.g., between points 221 and 225, or the like). As can be seen, the distance between point 221 and the scanning redirection system 215 is different from the distance between point 225 and the scanning redirection system 215. This is because the projection surface 202 is substantially non-orthogonal to the chief ray 203. In certain embodiments, the projection system 201 may include one or more additional components that are omitted here for expediency and/or clarity. For example, the projection system may include a waveguide, such as to transfer the light beam 209 from the projector 205 to an eye of the user via the lens 223.

In various embodiments, the light emitter 205 may comprise one or more instances of (as non-limiting examples) a laser, a superluminescent diode (SLED), a microLED, a resonant-cavity light-emitting diode (RCLED), a vertical-cavity surface-emitting laser (VCSEL) light source, or the like. The light emitter 205 may comprise a single light source or multiple light sources. In certain embodiments, such as embodiments in which multiple light sources are utilized, optical coupling devices (e.g., a beam combiner and/or dichroic plates) may also be utilized.

In at least one embodiment, the scanning redirection system 215 comprises a movable plate and a mirror arranged to be rotated about two mutually orthogonal axes. In certain embodiments, the mirror may rotate about one axis. In other embodiments, the scanning redirection system 215 may comprise two mirrors, such that each mirror rotates about one axis. In particular, each mirror may rotate about mutually orthogonal axes.

In general, the displacement of the lens 223 with respect to the scanning redirection system 215 may be changed dynamically during operation. In some examples, the lens 223 may comprise an electro-active polymer. As such, applying electric current to the lens 223 may physically deform the lens 223 and consequently the displacement of the lens 223 can be varied. In some examples, the lens 223 may be a piezo-actuated rigid or polymer lens, in which the lens is actuated with a driving signal to cause the lens to physically move to a different location. In some examples, the driving signal may be provided by a controller.

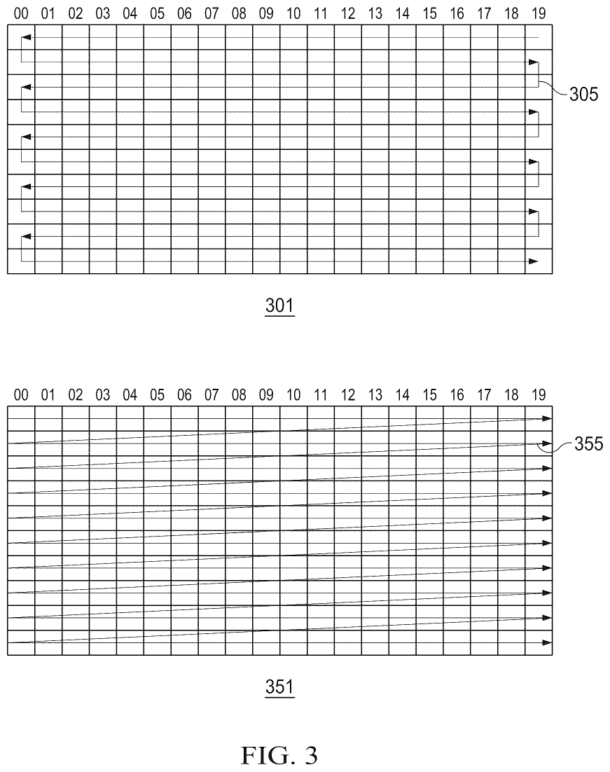

FIG. 3 depicts two alternative arrangements for scanning a simplified pixel grid in accordance with one or more embodiments. In these examples, an image may be projected by the projection system 201 by projecting each pixel of the entire image along a scan path comprising multiple locations that each ideally correspond to the location of a pixel in a typical pixel grid comprising a fixed number of rows and columns. In various embodiments, the projection of each pixel is performed via one or more light emitters emitting one or more light beams that each have a respective intensity, such as may correspond to a color intensity value associated with a particular pixel in a Red-Green-Blue (RGB) display mode, with a scanning redirection system (e.g., one or more redirecting mirrors) rotating or otherwise redirecting the one or more light beams along a configured scan path. In the two examples of FIG. 3, each row of a pixel grid is successively scanned and displayed prior to vertically transitioning to scan and display a successive row. It will be appreciated that any manner of scan path may be utilized in accordance with embodiments described herein. For example, scan paths may be utilized in which each column of a pixel grid is scanned and displayed prior to horizontally transitioning to scan and display a successive column; additional examples include concentric scan paths, unidirectional or bidirectional scan paths, etc. In certain embodiments, an interlaced projection may be implemented, for example, such that the image is projected from top to bottom and then from bottom to top (e.g., in an interlaced manner).

In the first example of FIG. 3, a first pixel grid 301 includes a 10×20 grid arranged as 10 rows of 20 pixels each, and is depicted with an example scan path 305. In the example scan path 305, the scanning begins at the top right (column 19 of the top row) and proceeds leftward, with one or more mirrors of a scanning redirection system (e.g., scanning redirection system 215 of FIG. 2) rotating in order to effectuate the scanning and display of successive locations along the scan path. At the leftmost pixel, the scanning of the first pixel grid 301 continues by proceeding downward to column 00 of the second row and then proceeding rightward. The example scan path 305 continues in this manner until all pixels of the first pixel grid 301 is completed.

In the second example of FIG. 3, a second pixel grid 351 includes an identical 10×20 grid, again arranged as 10 rows of 20 pixels each, and is depicted with an example scan path 355. In the example scan path 355, the scanning begins at the top left (column 00 of the top row) and proceeds rightward. At the rightmost pixel, the scanning of the first pixel grid 301 continues by proceeding downward to the second row and then proceeding leftward. Notably in contrast to example scan path 305 discussed above, the example scan path 355 does not indicate that rows are scanned and displayed in alternative horizontal directions; instead, each row is scanned and displayed horizontally from left to right in turn, after which the scanning redirection system 215 returns to an original position. This example, commonly termed “raster scanning” includes a flyback period in which no image is projected. The example scan path 355 continues in this manner until all pixels of the second pixel grid 351 is completed.

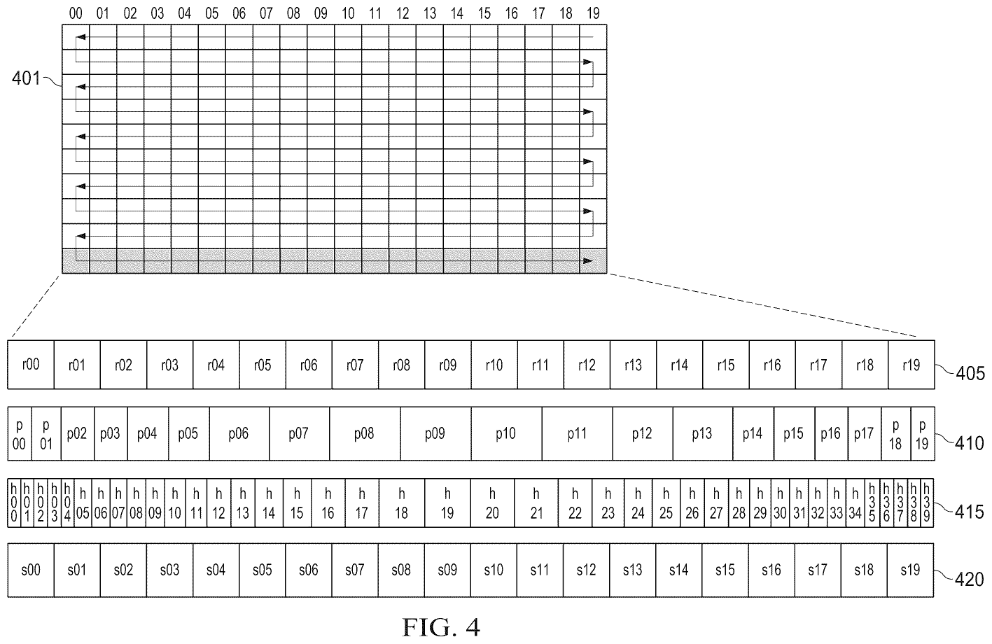

FIG. 4 illustrates a simplified pixel grid 401 and various pixel positioning schemes associated with the scan and display of one scan line of pixels in that pixel grid.

In a rendered ideal pixel row 405, the bottom row of pixel grid 401 is simply depicted and magnified, displaying one row of twenty pixels designated as r00, r01, . . . , r19. This ideal rendering reflects an optimal placement for a projected display of the pixel row, with no resampling needed to compensate for any misalignment of projected pixels caused by a fixed modulation period with a variable-speed scanning redirection system.

In example projected pixel row 410, a fixed modulation frequency is used to render projected pixels p00, p01, . . . , p19. Given the fixed modulation period and a changing mirror speed (common with resonant mirrors or other dynamic scanning redirection systems in which the velocity of the system follows a sinusoidal or other periodic frequency), the projected pixel locations and widths change along the rendered pixel scan line as shown. Notably, few of the individual projected pixels of example projected pixel row 410 “line up” with the original placement of the corresponding pixels in the simplified pixel grid 401, as shown via the rendered ideal pixel row 405. For example, while the respective intensity (e.g., color and brightness) of any light beams emitted to project pixel p00 will match a set of respective intensities associated with the original rendered pixel r00, the respective intensities of other light beams used to project and display other pixels in example pixel row 410 is less certain. For example, the respective intensities used to display pixel p13, which is to significantly wider than original rendered pixel r13 and misplaced with respect to that original rendered pixel, will likely be a resampled combination of those intensities associated with the r14 and r15 pixels—resulting in significantly reduced contrast between those neighboring pixels, in comparison to that provided via the original pixel grid and the rendered ideal pixel row 405.

One solution is to increase the fixed modulation frequency, as shown in example rendered pixel row 415 with respect to projected pixels h00, h01, h39. This requires faster switching speeds (increasing instantaneous currents, and therefore power requirements), as well as to provide a greater bandwidth of information into the modulation controller. Moreover, the solution fails to solve the problem of pixel size mismatch, and is associated with greatly increasing (e.g. doubling, in the depicted example) the quantity of pixels rendered for each pixel row, along with another corresponding increase in power requirements.

In contrast, embodiments instead utilize pixel-level differentiated modulation timing to modify placement of each pixel (effectively shifting the pixel boundaries) at determined locations along the scan path, as shown in the example rendered pixel row 420 with respect to projected pixels s00, s01, s19. In this case the pixel boundaries and widths are lined up, within quantization limits of the placement capability, with the ideal boundaries and widths of rendered pixel row 405. No resampling is required. Timing information associated with each location along the scan path may, in certain embodiments, comprise individual duration values for each such location, with the lower limits of those duration values being dependent upon an available switching frequency of the relevant light emitter itself.

This solution achieves several objectives. As one example, fewer pixels need to be rendered and processed, reducing graphics pipeline energy requirements. As another, the modulation frequency is still low—in particular, switching is no faster than the original switching speed, reducing instantaneous currents. A 1-GHz clock coupled to a timing block for the modulation controller corresponds to a 1-ns quantization of pixel timing control, allowing pixel positioning at typical display frequencies to fall within 10%-25% of a pixel's width. In certain embodiments, higher clock frequencies are possible, allowing even greater pixel positioning control.

In certain embodiments, the timing information for a particular instance of a display system in accordance with techniques described herein may be generated via a calibration process, such as to determine a duration for the display of a projected pixel at each of every location along a predefined scan path, such as if scan path 305 or scan path 355 is to be used in order to project a rendered display of pixel grid 301 on a projection surface (e.g., projection surface 202 of FIG. 2 and/or display area 120 of FIG. 1). As non-limiting examples, the calibration process may be performed as part of system manufacture, at system initialization or boot, during periodic or irregular maintenance of the display system, in response to a user request, or at some other time. In certain embodiments, such a calibration process may include determining a respective duration time to associate with each location on a scan path of a projection surface based on a determination of a relative time or distance associated with that particular location on the scan path. For example, the calibration process may include determining the relative time or distance for a reflection of at least a portion of a light beam to reach an eye of a user after that light beam is directed (or redirected) to that particular location on the scan path.

In certain embodiments, modified placements of pixels along a scan line as described herein may be used to adjust the effective resolution being displayed, such as in response to a detected focal point of the user. For example, in various embodiments the placement or effective resolution may be adjusted at one or more portions of an image based on a detected orientation of a user's eye(s).

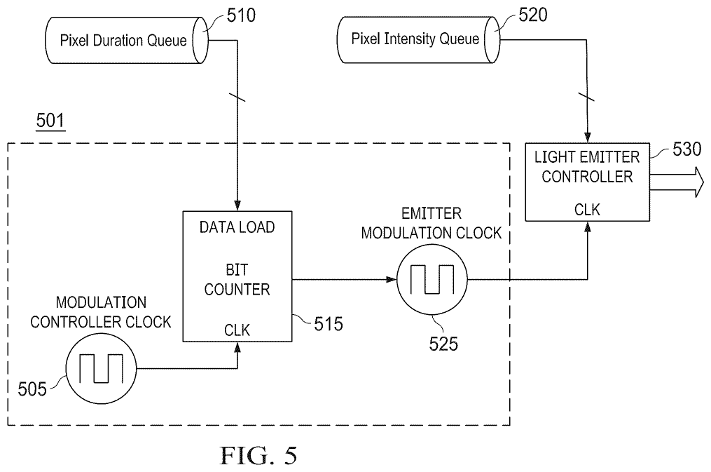

FIG. 5 depicts an example timing block 501 for a modulation controller in accordance with one or more embodiments. In the depicted embodiment, a modulation controller clock 505 is coupled to the clock input of a bit counter 515. The data input of the bit counter 515 is coupled to a pixel duration queue data module 510, which stores a respective timing value associated with each of a plurality of pixel display locations of a projection surface. An output of the bit counter 515 is provided to an emitter modulation clock 525, the output of which is coupled to the clock input of a light emitter controller 530. A data input of the light emitter controller 530 is coupled to a pixel intensity queue data module 520, which stores one or more intensity values associated with each of the plurality of pixel display locations.

In operation, the bit counter 515 is provided with a pixel duration value for a first pixel display location from the pixel duration queue module 510. In the depicted embodiment, the pixel duration value is specified as a quantity of clock cycles for which the intensity values projected at the first pixel display location are to remain constant—in short, the duration for which the particular intensity values associated with that pixel of the image are to be displayed. Bit counter 515 provides an output pulse to the emitter modulation clock 525 only after a count to the first provided pixel duration value is completed. At each cycle of the emitter modulation clock 525, the light emitter controller 530 loads the next set of pixel intensity values from the pixel intensity queue module 520 in order to modulate an intensity of one or more light beams redirected along a scan path in order to display a next pixel at the successive location on the scan path.

For purposes of illustration, assume that modulation controller clock 505 is operated at a 1 GHz clock frequency, and that bit counter 515 is a 12-bit counter. Further assume that an optimally placed display projection of four adjacent pixels in a scan line is associated with the following timing:

| Pixel: | A | B | C | D |
|---|---|---|---|---|
| Duration: | 10 ns | 13 ns | 13 ns | 11 ns |

The 1 GHz input clock frequency indicates that each clock cycle requires 1 ns, which is the lower quantization limit for pixel placement in this example. Assume that at a first rising edge of a clock pulse from the modulation controller clock 505, the bit counter 515 loads a pixel duration value of ‘10’ from the pixel duration queue module 510, and that the light emitter controller 530 initiates (such as in response to the rising edge of a previous clock pulse received from emitter modulation clock 525) an intensity modulation of one or more light emitters in order to utilize intensity values associated with pixel A that have been loaded from the pixel intensity queue module 520. Following ten clock cycles of the modulation controller clock 505, lasting a total of 10 ns, the bit counter 515 loads the next pixel duration value of ‘13’ from the pixel duration queue module 510, and triggers a clock pulse of the emitter modulation clock 525, which in turn causes the light emitter controller 530 to load the next set of intensity values (those associated with pixel B) from the pixel intensity queue module 520. Operations thus continue: following 13 clock cycles of the modulation controller clock 505, lasting a total of 13 ns, the bit counter 515 loads the next pixel duration value of ‘13’ from the pixel duration queue module 510, and triggers another clock pulse of the emitter modulation clock 525, which in turn causes the light emitter controller 530 to load the next set of intensity values (those associated with pixel C) from the pixel intensity queue module 520. Following another 13 clock cycles of the modulation controller clock 505, lasting a total of 13 ns, the bit counter 515 loads the next pixel duration value of ‘11’ from the pixel duration queue module 510, and triggers another clock pulse of the emitter modulation clock 525, which in turn causes the light emitter controller 530 to load the next set of intensity values (those associated with pixel D) from the pixel intensity queue module 520. Operations continue in this manner in order to display a pixel for each queued set of pixel intensity values for the duration indicated via the pixel duration queue module 510 for the corresponding pixel projection location.

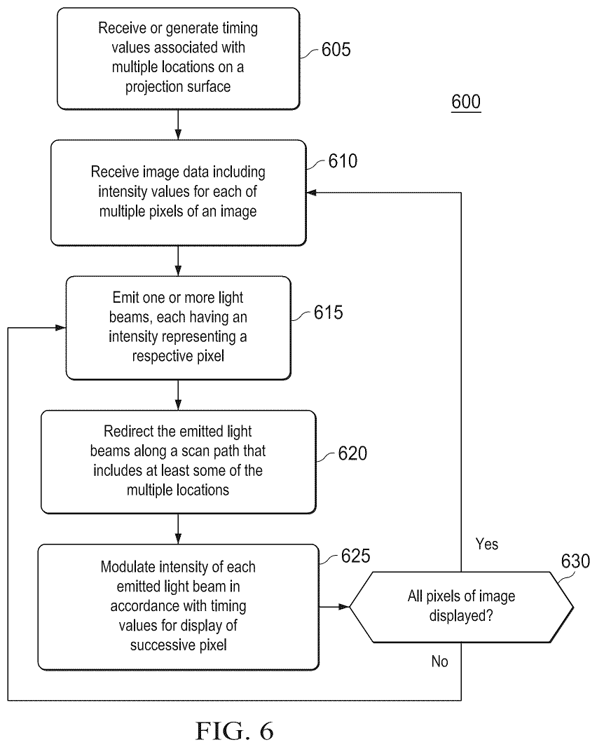

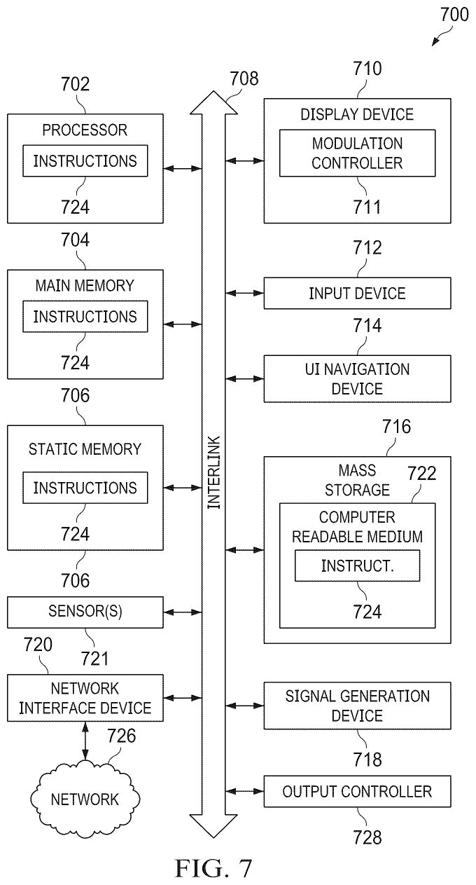

FIG. 6 is a block diagram illustrating an overview of an operational routine 600 of a processor-based display system in accordance with one or more embodiments. The routine may be performed, for example, by an embodiment of HWD device 110 of FIG. 1, by one or more components of system 700 of FIG. 7, or by some other embodiment.

The routine begins at block 605, in which the processor-based display system receives or generates timing values associated with multiple locations on a projection surface, such as locations of display area 120 in the embodiment of FIG. 1, or locations on the projection surface 202 in the embodiment of FIG. 2. In certain embodiments, the timing values may be generated as part of a calibration routine associated with the display system; such a calibration routine may be implemented, for example, as part of an initialization or boot routine, periodically, or in response to a manual request from a user.

The routine proceeds to block 610, in which the processor-based display system receives image data that includes intensity values (e.g., color values, brightness values, etc.) for each of multiple pixels of an image. The routine then proceeds to block 615.

At block 615, the processor-based display system emits one or more light beams, each having an intensity representing a pixel of the received image. In certain embodiments, the light beams may be emitted by one or more light emitters, such as SLP 144 of the embodiment of FIG. 1, or light emitter 205 in the embodiment of FIG. 2. The routine proceeds to block 620, in which the emitted light beams are redirected (via a scanning redirection system such as scan mirror 142 of the embodiment of FIG. 1, or scanning redirection system 215 in the embodiment of FIG. 2) along a scan path that includes at least some of the multiple locations on the projection surface (such as locations of display area 120 in the embodiment of FIG. 1, or locations on the projection surface 202 in the embodiment of FIG. 2). The routine then proceeds to block 625.

At block 625, the processor-based display system modulates (e.g., via a modulation controller such as modulation controller 501 of FIG. 5) the intensity of each emitted light beam in accordance with timing values for the display of a pixel successively located along the scan path. In the depicted embodiment, the routine then proceeds to block 630, in which the processor-based display system determines whether all pixels of the received image have been displayed. If not, the routine returns to block 615 and emits the intensity-modulated one or more light beams in order to display the next pixel of the image along the scan path. If it is instead determined that all pixels of the received image have been displayed, the routine returns to block 610 to receive intensity values for each of multiple pixels associated with a next image. It will be appreciated that, in various embodiments and circumstances, successive images may comprise similar or identical graphical content as a previous image and may not be associated with receiving “new” image data, such as if a display of the projected graphical content is to be refreshed or updated in accordance with a specified display frequency.

FIG. 7 is a component-level block diagram illustrating an example of a system 700 suitable for implementing one or more embodiments. In alternative embodiments, the system 700 may operate as a standalone device or may be connected (e.g., networked) to other systems. In various embodiments, one or more components of the system 700 may be incorporated within a head wearable display or other wearable display to provide AR, VR, or other graphical content (including graphical representation of one or more textual items). It will be appreciated that an associated to HWD device may include some components of system 700, but not necessarily all of them. In a networked deployment, the system 700 may operate in the capacity of a server machine, a client machine, or both in server-client network environments. In an example, the system 700 may act as a peer system in peer-to-peer (P2P) (or other distributed) network environment. The system 700 may be a personal computer (PC), a tablet PC, a set-top box (STB), a personal digital assistant (PDA), a mobile telephone, a web appliance, a network router, switch or bridge, or any system capable of executing instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

System (e.g., a mobile or fixed computing system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The system 700 may further include a display unit 710 comprising a modulation controller 711 (e.g., the modulation controller 501 of FIG. 5), an alphanumeric input device 712 (e.g., a keyboard or other physical or touch-based actuators), and a user interface (UI) navigation device 714 (e.g., a mouse or other pointing device, such as a touch-based interface). In one example, the display unit 710, input device 712, and UI navigation device 714 may comprise a touch screen display. The system 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The system 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a computer readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the system 700. In an example, one or any combination of the hardware processor 702, the main memory 704, the static memory 706, or the storage device 716 may constitute computer readable media.

While the computer readable medium 722 is illustrated as a single medium, the term “computer readable medium” may include a single medium or multiple media (e.g., a centralized or distributed database, and/or associated caches and servers) configured to store the one or more instructions 724.

The term “computer readable medium” may include any medium that is capable of storing, encoding, or carrying instructions for execution by the system 700 and that cause the system 700 to perform any one or more of the techniques of the present disclosure, or that is capable of storing, encoding or carrying data structures used by or associated with such instructions. Non-limiting computer readable medium examples may include solid-state memories, and optical and magnetic media. In an example, a massed computer readable medium comprises a computer readable medium with a plurality of particles having invariant (e.g., rest) mass. Accordingly, massed computer readable media are not transitory propagating signals. Specific examples of massed computer readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the system 700, and includes digital or analog communications signals or other intangible medium to facilitate communication of such software.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method for displaying an image, the method comprising:
receiving timing information specifying a timing value associated with each of multiple locations on a projection surface; and
displaying the image on the projection surface by:
emitting one or more light beams using a first set of intensity values;
redirecting the one or more emitted light beams along a scan path that includes at least some of the multiple locations; and
modulating, during the redirecting of the one or more emitted light beams along the scan path and in accordance with the timing information, the one or more emitted light beams to display one or more pixels of the image using a respective set of intensity values at each location of the at least some multiple locations.

2. The method of claim 1, further comprising generating the timing information for a display device.

3. The method of claim 1, further comprising associating each of the at least some multiple locations with one or more pixels of the image.

4. The method of claim 1, wherein each specified timing value indicates a duration for displaying a pixel using a respective set of intensity values at a respective location on the projection surface.

5. The method of claim 1, wherein the projection surface is part of an optical element that includes at least a portion of one or more eyeglass lenses.

6. The method of claim 1 to wherein the projection surface is part of an optical element that includes at least a portion of a vehicle window.

7. The method of claim 1, wherein receiving the timing information includes receiving at least two distinct timing values that are respectively specified for each of at least two adjacent locations of the at least some multiple locations.

8. A display system, comprising:
a processor to receive timing information that specifies a timing value for each of multiple locations on a projection surface of an optical element;
at least one light emitter to emit, using a first set of intensity values, one or more light beams for displaying an image on the projection surface;
a scanning redirector to redirect the one or more emitted light beams along a scan path that includes at least some of the multiple locations; and
a modulation controller to modulate, during the redirection of the one or more emitted light beams and in accordance with the timing information, the one or more emitted light beams to display one or more pixels of the image using a respective set of intensity values at each location of the at least some multiple locations.

9. The display system of claim 8, further comprising the optical element.

10. The display system of claim 8, wherein the processor is further to generate the timing information for a display device via a calibration process.

11. The display system of claim 8, wherein each specified timing value indicates a duration to display a pixel using a respective set of intensity values at a respective location on the projection surface.

12. The display system of claim 8, wherein the processor is further to associate each of the multiple locations on the projection surface with one or more pixels of the image.

13. The display system of claim 8, wherein the optical element includes at least a portion of one or more eyeglass lenses.

14. The display system of claim 8, wherein the optical element includes at least a portion of a vehicle window.

15. The display system of claim 8, wherein at least two of the specified timing values are distinct values respectively specified for each of at least two adjacent locations of the multiple locations.

16. A head wearable display (HWD) device, comprising:
an optical element; and
the display system of claim 8.

17. The head wearable display (HWD) device of claim 16, wherein the optical element includes at least a portion of one or more eyeglass lenses.

18. The head wearable display (HWD) device of claim 16, wherein the optical element includes at least a portion of a vehicle window.

19. The head wearable display (HWD) device of claim 16, wherein at least two of the specified timing values are distinct values respectively specified for each of at least two adjacent locations of the multiple locations.
